(19) United States
(12) Patent Application Publication
(10) Pub. No.: US 2023/0372177 A1
(43) Pub. Date: Nov. 23, 2023

(54) DEVICE FOR SUPPORTING A PART OF A HUMAN BODY

(71) Applicant: COMPAGNIE GENERALE DES ETABLISSEMENTS MICHELIN, Clermont (FR)

(72) Inventors: BERTRAND DAVAL, Clermont-Ferrand (FR); CHRISTOPHE LE CLERC, Clermont-Ferrand (FR); MATHIEU GIRARD, Clermont-Ferrand (FR); GILLES TOUATI, Amiens (FR)

(21) Appl. No.: 18/031,436

(22) PCT Filed: Oct. 8, 2021
(86) PCT No.: PCT/FR2021/051750

§ 371 Date: Apr. 12, 2023

(30) Foreign Application Priority Data
Oct. 12, 2020 (FR) FR2010419

(51) Int. Cl. A61G 13/12; A61G 7/057

(52) U.S. Cl. CPC A61G 13/1265; A61G 7/05769; A61G 7/05784

(57) ABSTRACT

A device for supporting a part of a human body is made up of a first element forming a pneumatic cavity having a valve, the pneumatic cavity being kept at a pressure of less than 0.04 bar under load and at least the surface of the at least one first element that comes into contact with the part of a human body is covered by a “3D spacer” fabric.

The present invention relates to a device for supporting a part of a human body in a stationary position. Although it is not limited to this type of application, the invention will be described more particularly with reference to patients in a hospital environment when they must keep at least one part of their body in a stationary position bearing against a support.

Other types of application are, for example, seats for persons that must remain stationary for long periods of time in chairs or, for example, seats for wheelchairs.

In numerous situations, hospitalized patients, whether they are in a room or else in the operating theatre, must remain lying down without moving. Irrespective of the quality of the mattress, the pressure exerted by the weight of the patient between the bones and the areas where the mattress bears against the skin and the flesh appears to lead to necrosis or bedsores.

Such unpleasantness can effectively be observed after surgery lasting several hours when the patient must be kept in a position with some bearing points. This unpleasantness can also appear in patients who are hospitalized for long periods of time.

A technique currently used in hospitals consists in the use of foam or gel wedges to improve the distribution of pressure.

These devices have proven bulky in terms of storage and can lead to bedsores all the same because of the pressures exerted on the skin and the flesh.

Document US 2009056030 describes a mattress for a hospital bed in combination with an air circulation system for ventilating the surface of the skin of the patient, who is lying down in the bed, to reduce the risks of bedsores by discharging heat and moisture. This is a complex and expensive device.

Document US 2017065473 describes a more economical system with an inflatable wedge for supporting a patient, the inflation of which regularly varies and which also provides ventilating the surface of the skin.

The latter system, although it is more economical, is not considered to be sufficient to avoid the risks of bedsores forming and remains limited to certain uses.

The inventors thus set themselves the object of proposing a device for supporting a part of a human body, whatsoever that part may be, which is simple to implement, the manufacturing costs of which are limited, and which makes it possible to reduce the risk of lesions or bedsores appearing.

This aim has been achieved according to the invention by a device for supporting a part of a human body, the said device being made up of at least one first element forming a pneumatic cavity, the said pneumatic cavity having a valve, the said pneumatic cavity being kept at a pressure of less than 0.04 bar under load and at least the surface of the said at least one first element that comes into contact with the said part of a human body being covered by a “3D spacer” fabric.

Within the meaning of the invention, a pressure under load corresponds to the pressure measured when the part of the human body bears against the support device.

Within the meaning of the invention, “3D spacer” fabrics are three-dimensional fabrics of “XD spacer fabric” type, which are sold by the company Baltex, or “3MESH SPACER FABRIC” type, which are sold by the company Muller, which are already used in medical applications. These three-dimensional fabrics have the advantage of ensuring the surface of the skin of the human body in contact with the support module is ventilated. Such fabrics are, for example, described in documents US 2018187348, EP 1347087, EP 2408957 and WO 2012098130.

Such “3D spacer” fabrics can be woven or knitted fabrics made up of two walls connected to one another by one or more filaments. These filaments may have different natures: polyester, polyamide, polypropylene or cotton. These filaments can be used in raw form, but also can be sized or coated to modify the feel or to limit the development of viruses or bacteria. These filaments have a certain resilience given to them by their diameter, which is greater than 30 microns, preferably greater than 100 microns, and have a density and a pattern designed to withstand compressive forces; they thus impart a buckling stress, that is to say a compressive resistance or buckling strength of these filaments, to the “3D spacer” fabric.

Advantageously, the “3D spacer” fabric exhibits a buckling stress greater than the inflation pressure of the pneumatic cavity.

Within the meaning of the invention, the buckling stress of the fabric is the stress perpendicular to the mean plane of the fabric which causes the filaments connecting the two surfaces to buckle. Above this stress, the two surfaces of the fabric move very close together and cannot perform their ventilation role.

The mean plane of the fabric corresponds to the surface of the fabric when it is laid flat.

The buckling stress is measured in accordance with the standard ISO 3386-1.

More advantageously still, the buckling stress of the “3D spacer” fabric is less than 0.2 bar.

Such buckling stresses make it possible to combine ventilation of the skin of the human body and comfort in support.

According to a preferred embodiment of the invention, the thickness of the “3D spacer” fabric is less than 10 mm.

Preferably according to the invention, the permeability of the “3D spacer” fabric to air is greater than 1000 l/dm²×min at a pressure of 1 mbar.

The permeability of the fabric is measured in accordance with the standard ISO 9237.

According to a first embodiment variant of the invention, the first element of the support device for a part of a human body is advantageously made up of a sheet of thermoplastic polymer preferably exhibiting a modulus of elasticity under tension at 10% elongation of less than 20 MPa, the said sheet of thermoplastic polymer being folded and heat sealed at its edges.

According to a second embodiment variant of the invention, the first element of the support device for a part of a human body is advantageously made up of at least two sheets of thermoplastic polymer preferably exhibiting a modulus of elasticity under tension at 10% elongation of less than 20 MPa, the said at least two sheets of thermoplastic polymer being heat sealed edge to edge.

The moduli of elasticity under tension at 10% elongation are measured in accordance with the standard DIN 53504.

The sheets of thermoplastic polymer can notably be heat sealed by way of ultrasound, conduction or high frequency.

Preferably, the one or more sheets of thermoplastic polymer exhibit a modulus of elasticity under tension at 10% elongation of less than 10 MPa.

More preferably still, the one or more sheets of thermoplastic polymer have a thickness of less than 1 mm and even more preferably less than 0.5 mm.

Such a material, in a known manner, enables the simple production of an element having a sealed cavity that can be pressurized. A particularly suitable material is a thermoplastic polyurethane. It is possible to realize heat sealing by locally bringing the sheet to its melting temperature. The stiffness properties of the sheet will make it possible to contribute to reducing the risks of bedsores when it is in contact with the skin.

When the first element is made up of at least two sheets of thermoplastic polymer, the one or more sheets of thermoplastic polymer that do not come into contact with the skin of the human body are advantageously reinforced. This reinforcement may be on the basis of fibres or fabric and leads to a sheet of thermoplastic polymer that is stiffer than one exhibiting a modulus of elasticity under tension at 10% elongation of less than 20 MPa.

According to the invention, the valve of the said first element makes it possible to keep the pressure under load that is required under the effect of the weight of the part of the human body that the element bears against, and possibly to control the pressure when the device is in use.

The valve is advantageously positioned so that it is made accessible during use and cannot come into contact with the human body.

More advantageously still, the valve is a gate valve to best ensure leaktightness.

The inflation pressure of the first element is advantageously greater than 0.005 bar underneath the weight of the human body.

The first element of the support device for a part of a human body is advantageously inflated with an inert and/or purified gas in order to avoid any risk of additional infection in the event of an accident relating to one of the modules that leads to a leak, notably in the event of use in a hospital environment.

Preferably according to the invention, the first element is kept at a pressure less than or equal to 0.03 bar underneath the weight of a part of the human body.

According to one embodiment variant of the invention, the support device for a part of the human body has a second element supporting the first element, the second element preferably being made up of a deformable structure and preferably having means for stabilizing the first element.

The deformable nature of the structure making up the second element of the support device for a part of the human body contributes to the comfort of the patient and to reducing the risk of bedsores appearing.

Advantageously according to the invention, the second element of the support device for a part of a human body is made up of multiple stackable portions. Making a second element in multiple portions makes it possible first of all to be able to modify the volume and the height of this second element so as to enable simple adaptation of the device to the height of the human body that must be supported, or more simply to a type of position; if, for some reason, it is necessary to raise up the part of the body to be supported, all that needs to be done is to add one or more portions to obtain the desired dimension.

According to a first embodiment variant of the invention, the second element of the support device for a part of the human body is at least partially made up of a polymer foam exhibiting a compressive stiffness of between 5 KPa and 50 KPa.

The compressive stiffness is measured in accordance with the standard ISO 3386/1.

According to a preferred embodiment of the invention, the second element of the support device for a part of the human body is at least partially made up of a pneumatic cavity, the said cavity of the said second element having a valve and the said cavity of the said second element being kept at a pressure of between 0.05 and 1 bar underneath the weight of the human body.

According to other embodiments of the invention, the second element of the support device for a part of the human body may have an element having a pneumatic cavity combined with one or more other, non-pneumatic elements. It may, for example, be one of the stackable elements described above. Such a variant can make it possible to create a larger volume after the placement of the part of the human body to be supported and thus facilitate this placement, the pneumatic portion still not being inflated when the human body is positioned and the volume of the second element thus being reduced in comparison with its volume during use.

The support device for a part of a human body thus described according to the invention makes it possible to support the said part of the human body in a desired position, while reducing the risk of bedsores appearing in the areas of contact with the support device.

The inventors have demonstrated that maintaining the first element of the support device for a part of a human body at the selected pressure under load, the said first element being covered with a “3D spacer” fabric on its surface that comes into contact with the human body, reduces the risk of bedsores appearing.

The inventors have effectively shown that, at such pressures, it was possible to support a part of a human body for lengthy periods of time without seeing the appearance of necrosis or bedsores that are difficult to treat.

The presence of a “3D spacer” fabric advantageously having the features as described above, when in contact with the skin of the part of the body that is supported, moreover makes it possible to discharge moisture and heat and thus contributes to conserving the skin that is in contact with the support device.

Since the first element of the support device for a part of a human body is advantageously made up of at least one sheet of thermoplastic polymer exhibiting a modulus of elasticity under tension at 10% elongation of less than 20 MPa, and preferably less than 10 MPa, it is produced simply and inexpensively.

The selection of this thin and deformable material makes it possible to closely follow the part of the human body that is supported and therefore to optimize the contact surface area between the first element and the part of the human body. The weak inflation pressure of the first element, advantageously realized with one or more sheets of thermoplastic polymer, moreover leads to a contact pressure against the part of the human body that is supported that is as uniform as possible.

Moreover, producing this first element of the support device for a part of a human body from heat sealable material allows a relatively accurate shape to be obtained. Heat sealing makes it possible to define the shape of the first element accurately such that the support device can optimally bear against the selected zones of the part of the human body. Specifically, the inventors have demonstrated that they could obtain shapes that bear against the selected areas of the part of the human body and thus ensure its support at the indicated pressure under load of less than 0.04 bar.

Furthermore, when the support device for a part of a human body is produced with a second element, it is advantageously possible to separate out the functions. For the one part, the second element provides the volume necessary to position the part of the human body as desired and the stiffness to ensure stability. For the other part, the first element with reduced volume can be easily kept at the selected pressure and produced even more accurately to bear against the part of the human body at the desired locations.

More advantageously still, the second element is provided with means for stabilizing the first element in the desired position and thus makes it possible for the one part to ensure the desired bearing points and for the other part to ensure the stability of these bearing points. These means can be directly linked to the shape of the second element, which can be provided to receive the first element and prevent it from moving, notably in the presence of the part of the human body. It is still possible to provide hook systems between the first and second elements; this may involve, for example, mechanical fixing systems with textile hooks and loops, sold under the trade name “Velcro”, which are simple to use and enable adjustable positioning or any other type of fixing means, such as clips, a zip, snap fasteners, etc.

The low production costs for the support device according to the invention also permit the availability of devices of different heights or shapes for better adaptation to the part of the human body to be supported, or else for adapting to the height or the build of the human body. This selection of heights of the device also makes it possible to optimize the positioning of the bearing points on the part of the human body to be supported.

According to one embodiment variant of the invention, the “3D spacer” fabric is provided as removable and separable from the first element so as to be able to be correctly cleaned and/or changed regularly.

It is also possible to provide a cover made from the “3D spacer” fabric that envelops all of the first element forming the pneumatic cavity and is intended to come into contact with the part of the human body, or else, if the second element is present, a cover enveloping the entirety of the support device. In all cases, these covers are provided as removable so as to be correctly cleaned and/or changed regularly. In the case of a cover which envelops the first and second elements of the support device, the cover advantageously contributes to stabilizing the two elements together.

As explained above, the first element may be made from one or more sheets of thermoplastic polymer.

In the case of a sheet of thermoplastic polymer that is folded, or in the case of two sheets of thermoplastic polymer, the first element may take the form of a cushion, the sheet or the two sheets of thermoplastic polymer being heat sealed at their periphery. Complementary heat sealing can also make it possible to create a cutout leading to a buoy shape. The heat sealing can be effected by way of ultrasound, conduction or high frequency.

One or more heat seals can also make it possible to limit the area forming a pneumatic cavity and thus make it possible to reduce, or even eliminate, the areas that bear against the part of the human body that is supported.

The first element of the support device for a part of a human body can also take the form of a tube. It can be produced from a sheet of thermoplastic polymer that is heat welded over its length so as to form a tube. Its ends are either heat sealed so as to form a shape of sachet type, or closed by two additional sheets of thermoplastic polymer that are heat sealed to close off the said ends.

According to other embodiment variants of the invention, the support device for a part of a human body may be placed on a highly stiff sheet to make the support device more stable.

Such sheets are, for example, sheets that are already used in hospitals and sold under the trade name “KOMACEL”.

The invention as has just been described, in addition to its advantages as regards the reduction in the risk of bedsores appearing, has numerous advantages notably linked to the inflatable nature of the elements making up a support device for a part of a human body. This is because, for the one part, the use of inflatable elements makes it possible to reduce their volumes when not in use or before use and thus facilitate their storage. In connection with this decrease in volume, it becomes possible to store a significant number and variety of these elements and thus to have available the model which is best suited to the situation, notably in terms of shape variety, at any time. For the other part, when a second element making up the support device for a part of a human body is also an inflatable element, in addition to the advantages mentioned it becomes possible for operators to reduce the volume of this second element, one of the functions of which is notably to provide volume, and thus to facilitate handling of a part of a human body. This is particularly important for patients for whom it is regularly necessary to move the supported part; the reduction in the volume of the second element, which is the bulkiest one, makes it possible to facilitate such an operation.

The invention also proposes a method for supporting a part of a human body implementing the device that has just been described, in which method, in a first step, the cavity of at least one first element of the support device for a part of the human body is partially filled with air, in a second step, the part of the human body is disposed on the said first element and, in a third step, the pressure of the said cavity of the first element of a support device for a part of the human body is regulated to a pressure less than 0.04 bar.

According to an advantageous variant of the invention, with the support device for a part of the human body having a second element at least partially forming a pneumatic cavity, in a fourth step of the method for supporting a part of a human body, the pressure of the said cavity of the second element of a support device for a part of the human body is regulated to a pressure of between 0.05 and 1 bar.

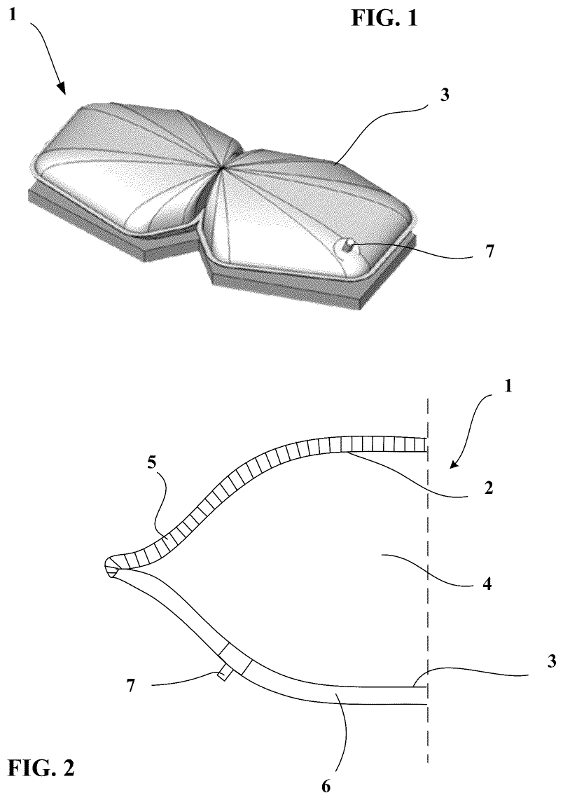

Further advantageous features and details of the invention will become apparent from the following description of exemplary embodiments of the invention and with reference to FIGS. 1 to 10, in which:

FIG. 1 shows a schematic depiction, in perspective, of a first embodiment of a support device in accordance with the invention,

FIG. 2 shows a schematic depiction, in partial section, of the support device of FIG. 1,

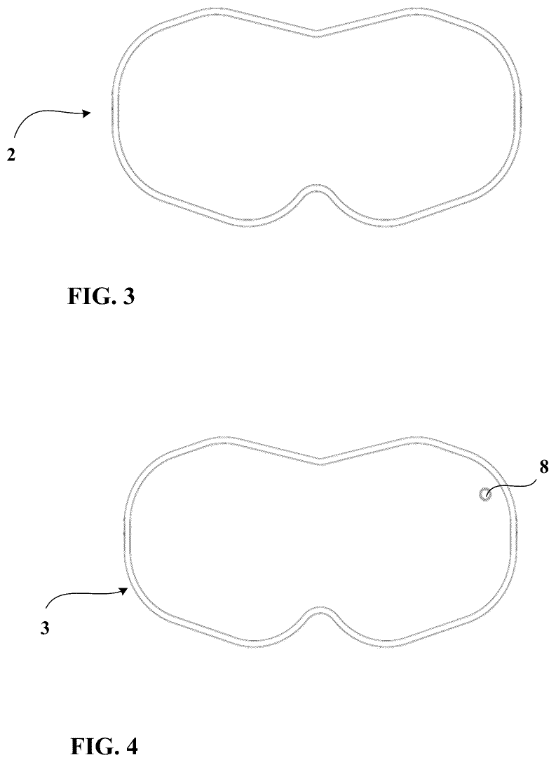

FIG. 3 shows a schematic depiction of one example of a portion making up the support device of FIG. 1,

FIG. 4 shows a schematic depiction of one example of another portion making up the support device of FIG. 1,

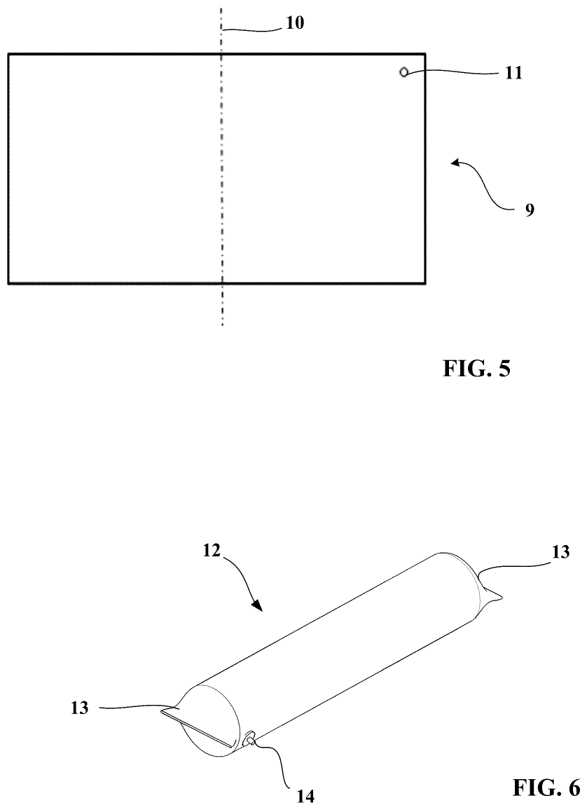

FIG. 5 shows a schematic depiction of another exemplary embodiment of a portion making up a support device in accordance with the invention,

FIG. 6 shows a schematic depiction, in perspective, of a second embodiment of a first element of a support device in accordance with the invention,

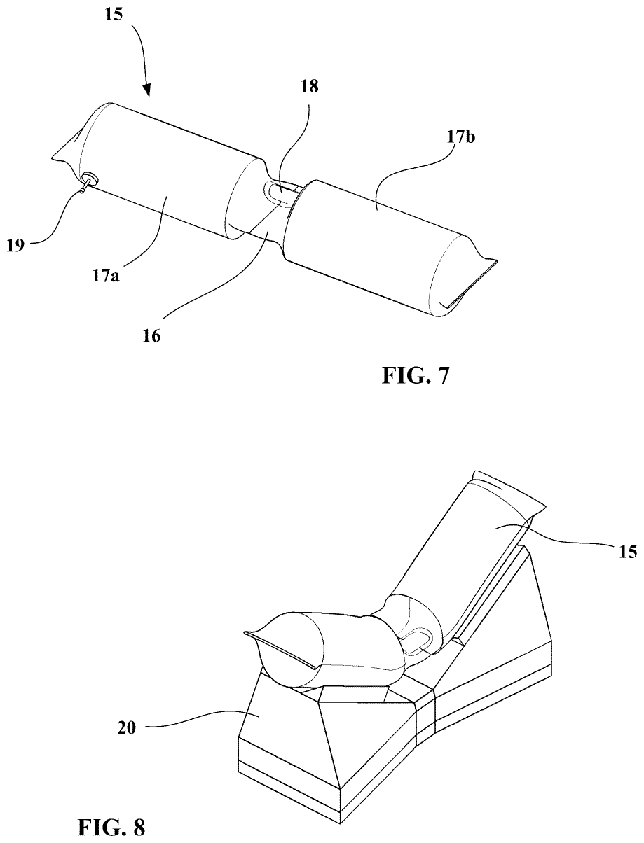

FIG. 7 shows a schematic depiction, in perspective, of a third embodiment of a first element of a support device in accordance with the invention,

FIG. 8 shows a schematic depiction, in perspective, of one embodiment of a support device having a first element as shown in FIG. 7 and a first embodiment of a second element,

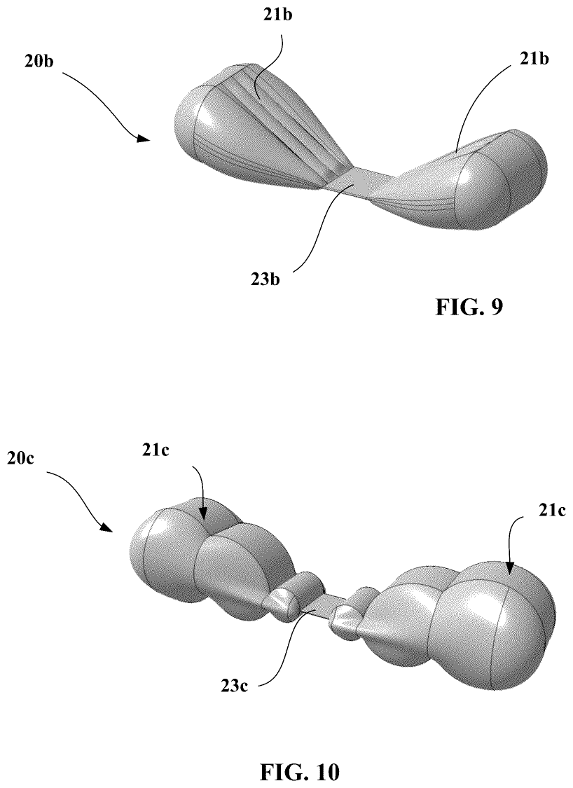

FIG. 9 shows a schematic depiction, in perspective, of a second embodiment of a second element of a support device as shown in FIG. 8,

FIG. 10 shows a schematic depiction, in perspective, of a third embodiment of a second element of a support device as shown in FIG. 8.

In order to make them easier to understand, the figures are not shown to scale.

In FIG. 1, the support device is made up of a first element 1 which takes the form of a cushion. It is made up of two sheets of thermoplastic polyurethane 2 and 3, sold under the name Tuftane TFL-1E, that exhibit a secant modulus of elongation equal to 9.8 MPa at 10% elongation and are heat sealed at their periphery. These two sheets of thermoplastic polyurethane 2 and 3 are heat sealed at their periphery so as to form a cavity 4, visible in FIG. 2.

FIG. 2 illustrates a schematic view, in partial section, of this first element 1 covered with a “3D spacer” fabric 5, sold under the reference Muller Textil T5683, on its surface intended to come into contact with the skin. This “3D spacer” fabric 5 is held on the outer surface of the sheet of thermoplastic polyurethane 2 by a cotton cover 6 which covers the outer surface of the sheet of thermoplastic polyurethane 3.

On the lower face, which is not intended to come into contact with the skin of the human body, there is shown a valve 7, visible in FIGS. 1 and 2, which makes it possible to adjust the pressure of the first element forming a pneumatic cavity.

Such a support device made up of a first element 1 in the form of a cushion is more particularly suited, for example, to the support of a head or a part of an arm or, with well-adapted dimensions, to making up a seat covering a chair.

FIGS. 3 and 4 illustrate the two sheets of thermoplastic polyurethane 2 and 3, respectively. In FIG. 4, the sheet of thermoplastic polyurethane 3 intended to form the surface that does not come into contact with the skin has a hole 8 for the passage of the valve 7.

To form the first element 1, these two sheets of thermoplastic polyurethane 2 and 3 advantageously have the same shape so as to be easily heat sealed to one another at their periphery and form the cavity 4.

FIG. 5 illustrates another way of forming a first element 1. This involves a single sheet of thermoplastic polyurethane 9, the shape of which has an axis of symmetry 10. The sheet of thermoplastic polyurethane 9 can be folded along this axis and heat sealed along its sides so as to form a cavity. The sheet of thermoplastic polyurethane 9 is also provided with a hole 11 to enable the passage of a valve.

FIG. 6 illustrates another type of embodiment of a support device for a part of a human body, made up of a first element 12 forming a pneumatic cavity which has the form of a tube closed at its two ends by heat sealing.

This tube is produced from a sheet of thermoplastic polyurethane sold under the name Tuftane TFL-1E, exhibiting a secant modulus of elongation equal to 9.8 MPa at 10% elongation. The sheet is rolled and heat sealed over its length so as to form a cylinder, the sealing advantageously being performed on the inside so as not to create a harsh relief on the outer surface of the tube forming the pneumatic cavity of this first element. The ends 13 of the cylinder are then heat sealed to give the appearance of a sachet shape. A valve 14 is present to ensure the pressurization of this first element 12 of the support device.

This first element 12 is also enveloped in a cover or envelope made up of a “3D spacer fabric”, sold under the reference Muller Textil T5683.

Such a support device made up of a first element 12 in the form of a tube is more particularly suited, for example, to the support of a part of a leg or an arm.

FIG. 7 illustrates a support device, the first element 15 of which has a cylindrical shape similar to that of the first element of FIG. 6 and which can be produced in the same way. An additional step during the manufacture consists in heat sealing a central area 16 which is thus flattened to form two portions 17a, 17b that will be able to be folded towards one another to form a V shape. In its central part, the first element 15 of the device retains a passage area 18 for ensuring equalization of the pressures in the portions 17a and 17b. A valve 19 is also present to ensure the pressurization of this first element 15 of the support device.

This first element 15 is also enveloped in a cover or envelope made up of a “3D spacer” fabric, sold under the reference Muller Textil T5683.

FIG. 8 shows a support device made up of the first element 15 and a second element 20 having a V shape. The second element 20 is produced from a foam sold by the company Recticel under the trade name “Situseal” with the reference T 46065, exhibiting a compressive stiffness of between 8 and 12 KPa. This second element 20, which is stiffer, imposes a V shape on the first element 15 intended to receive it as explained above, provided that a part of the human body bears against it.

According to an embodiment variant of the invention, the cover or envelope made up of a “3D spacer” fabric sold under the reference Muller Textil T5683 could envelop the assembly made up of the first element 15 and the second element 20.

According to a preferred embodiment variant of the invention, the second element 20 shown in FIG. 8 can be substituted with a second inflatable element 20b, as illustrated in FIG. 9. This second element 20b is designed to take a form similar to the second portion 20 shown in FIG. 8 once it is maintained under pressure underneath the weight of the human body. FIG. 9 thus describes a second element 20b having a V shape with two arms 21b and 22b that are separated by a flattened area 23b. Such an inflatable element 20b can be produced easily with sheets of thermoplastic polyurethane by heat sealing the sheets and adding heat sealed sheets of thermoplastic polyurethane to each of the arms 21b and 22b so as to form internal walls in the cavity of each of the arms to obtain relatively flat surfaces for receiving the first element 15. These heat sealed walls are put in place before each of the arms 21b and 22b are closed off by other heat sealed sheets of thermoplastic polyurethane.

FIG. 10 illustrates yet another embodiment variant similar to that shown in FIG. 9. The second element 20c is once more an inflatable element with arms 21c and 22c that are produced by a succession of beads forming a V-shaped structure intended to receive the first element 15 of the pelvis support. Such a bead-shaped structure is easily produced by heat sealing the internal walls.

Embodiments like those of FIGS. 9 and 10 are particularly practical because they are not very bulky when stored, since no element is inflated. Furthermore, they make it possible, as in the case of the embodiment of FIG. 8, to provide a large volume if necessary and stiffness for stabilizing the support device made up of the first and second elements, the second element being regulated to a pressure under load of between 0.05 and 1 bar. The volume of the first element 15 can thus be reduced to a minimum to make it possible to closely follow the part of the human body that is to be supported, with a pressure lower than 0.04 bar under load.

Tests were carried out with a support device having a first element 1 as shown in FIGS. 1 and 2 and a second element, which is not shown in the figures. This second element has an identical geometry to that of the first element and forms a pneumatic cavity.

This support device is intended to support an arm which rests on the support device.

When in storage, the first and second elements are completely deflated and are completely flat; their bulk is therefore reduced to a minimum.

Before the arm is put in place, the first element and the second element are partially filled with the inflation gas so as to detach the walls of the pneumatic cavities.

The arm is put in place on the support device and each of the first and second pneumatic elements is brought to and kept at the desired support pressure.

The determined pressures in this scenario for providing optimum support that make it possible to reduce the risks of bedsores appearing and ensure pneumatic support are as follows.

The pressures are given in the following table for each of the elements of the support device:

| | Pressure (bar) |
|---|---|
| First element | 0.014 |
| Second element | 0.055 |

1.-11. (canceled)

12. A device for supporting a part of a human body, the device comprising a first element (1) forming a pneumatic cavity (4),
wherein the pneumatic cavity (4) has a valve (7),
wherein the pneumatic cavity (4) is kept at a pressure of less than 0.04 bar under load, and
wherein at least a surface of the first element (1) that comes into contact with the part of the human body is covered with a 3D spacer fabric (5).

13. The device for supporting a part of a human body according to claim 12, wherein a buckling stress of the 3D spacer fabric (5) is greater than an inflation pressure of the pneumatic cavity (4).

14. The device for supporting a part of a human body according to claim 13, wherein the buckling stress of the 3D spacer fabric (5) is less than 0.2 bar.

15. The device for supporting a part of a human body according to claim 12, wherein a thickness of the 3D spacer fabric (5) is less than 10 mm.

16. The device for supporting a part of a human body according to claim 12, wherein a permeability of the 3D spacer fabric (4) is greater than 1000 l/dm²×min at a pressure of 1 mbar.

17. The device for supporting a part of a human body according to claim 12, wherein the first element (1) is made up of a sheet of thermoplastic polymer, and
wherein the sheet of thermoplastic polymer is folded and sealed at its edges.

18. The device for supporting a part of a human body according to claim 12, wherein the first element (1) is made up of at least two sheets of thermoplastic polymer (2, 3), and
wherein the at least two sheets of thermoplastic polymer are sealed edge to edge.

19. The device for supporting a part of a human body according to claim 12, wherein the device has at least one second element (20, 20b, 20c),
wherein the at least one second element (20, 20b, 20c) is made up of a deformable structure, and
wherein the at least one second element (20, 20b, 20c) has means for stabilizing the first element (1).

20. The device for supporting a part of a human body according to claim 19, wherein the at least one second element (20b, 20c) is at least partially made up of a cavity,
wherein the cavity of the at least one second element (20b, 20c) has a valve, and
wherein the cavity of the at least one second element (20b, 20c) is kept at a pressure of between 0.05 and 1 bar under load.

21. A method for supporting a part of a human body implementing the device according to claim 12, the method comprising:
in a first step, partially filling the pneumatic cavity (4) of the first element (1) with air;
in a second step, disposing the part of the human body on the first element (1); and
in a third step, regulating a pressure of the pneumatic cavity (4) of the first element (1) to a pressure less than 0.04 bar.

22. The method according to claim 21, wherein the device has a second element (20b, 20c) at least partially forming a pneumatic cavity, and further comprising a fourth step of regulating a pressure of the pneumatic cavity of the second element (20b, 20c) to a pressure of between 0.05 and 1 bar.
